(19) United States
(12) Patent Application Publication
(10) Pub. No.: US 2009/0027342 A1
(43) Pub. Date: Jan. 29, 2009

(54) OPTICAL MOUSE

(75) Inventor: SHOU-SHU KAO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/959,233

(22) Filed: Dec. 18, 2007

(30) Foreign Application Priority Data
Jul. 27, 2007 (CN) 200710075433.3

(51) Int. Cl. G06F 3/033

(52) U.S. Cl. 345/166

(57) ABSTRACT

An optical mouse (10) for controlling a display pointer of a computer (90) includes a main body (12) and a connecting line (14). The main body includes a wired module (40), a wireless module (50) and a battery module (80). The connecting line is detachably attached to the main body and the computer. The connecting line is configured for transmitting electric energy to the main body and transmitting operating signal to the computer. The optical module is defined to be functioning in a connected mode via the wired module when the connecting line connects the main body and the computer. The optical module is defined to be functioning in a wireless mode via the wireless module when the connecting line is detached from the computer or the main body.

### BACKGROUND OF THE INVENTION

1. Field of the Invention

The present invention relates to optical mouse and, particularly, to an optical mouse for controlling a display pointer on a computer.

2. Description of Related Art

At present, mechanical mouse and optical mouse are two of many types of pointing devices for computer. A mechanical mouse is a mouse that uses a rubber ball that makes contact with wheels inside the unit when it is rolled on a pad or desktop. When the ball is rolled in any direction, sensor inside the mouse detect this motion and move the on-screen pointer in the same direction. An optical mouse uses a light-emitting diode and photodiode to detect movement to the underlying surface. Optical mouse detect movement relative to the surface by examining the light reflected off it. The sensing of the optical mouse is more precise than the mechanical mouse, and makes the computer operation easier in general. With the development of the optical mouse easy to operate, wireless optical mice have coming to use. However, the power consumption of the wireless optical mice is large, so that battery often needs to be replaced or recharge with the optical mouse stop working. This will cause inconvenience to the user and reduces his/her work efficiency.

Therefore, a new optical mouse is desired in order to overcome the above-described problems.

### SUMMARY OF THE INVENTION

In one embodiment thereof, an optical mouse for controlling a display pointer on a computer includes a main body and a connecting line. The main body includes a wired module (40), a wireless module (50) and a battery module (80). The connecting line is detachably attached to the main body and the computer. The connecting line is configured for transmitting electric energy to the main body and transmitting operating signal to the computer. The optical module is defined to be functioning in a connected mode via the wired module when the connecting line connects the main body and the computer. The optical module is defined to be functioning in a wireless mode via the wireless module when the connecting line is detached from the computer or the main body.

Other advantages and novel features will become more apparent from the following detailed description when taken in conjunction with the accompanying drawings.

### BRIEF DESCRIPTION OF THE DRAWINGS

Many aspects of the optical mouse can be better understood with reference to the following drawings. The components in the drawings are not necessarily drawn to scale, the emphasis instead being placed upon clearly illustrating the principles of the present optical mouse. Moreover, in the drawings, like reference numerals designate corresponding parts throughout the several views.

FIG. 1 is an isometric view of an optical mouse with a connecting line detached from a main body thereof, in accordance with a present embodiment;

FIG. 2 is an isometric view of the optical mouse attached to a computer via the connecting line shown in FIG. 1; and

FIG. 3 is a flow chart of a processing device of the optical mouse shown in FIG. 1.

### DETAILED DESCRIPTION OF THE INVENTION

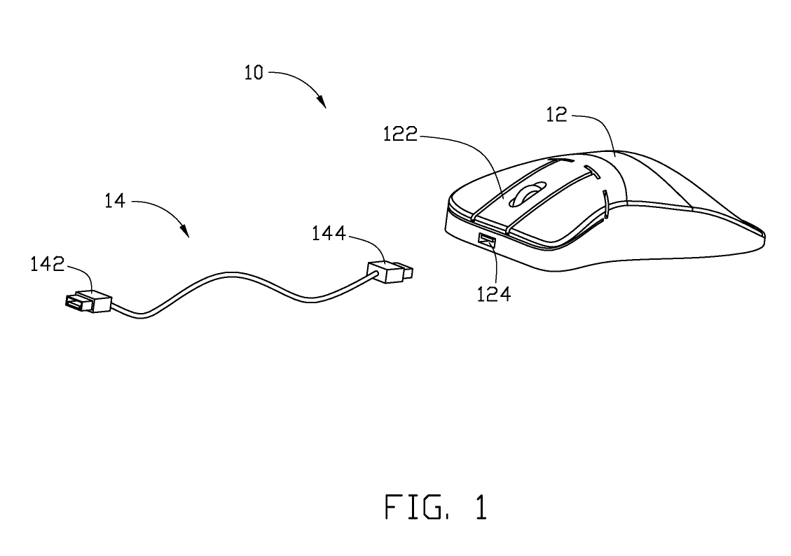

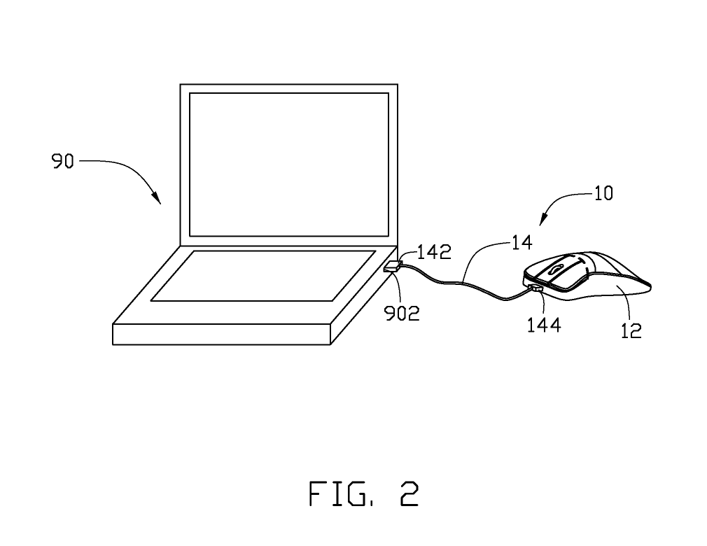

Referring to FIGS. 1 and 2, an optical mouse 10 in accordance with a present embodiment is used to move a displayed pointer (cursor) on a computer 90 to a desired location or position. The computer 90 has a universal serial bus (USB) port 902. The optical mouse 10 includes a main body 12 and a connecting line 14. The main body 12 has an operating portion 122 and a port 124. The operating portion 122 is being configured on an upper surface of the main body 12, and the port 124 is positioned at one end of the main body 12.

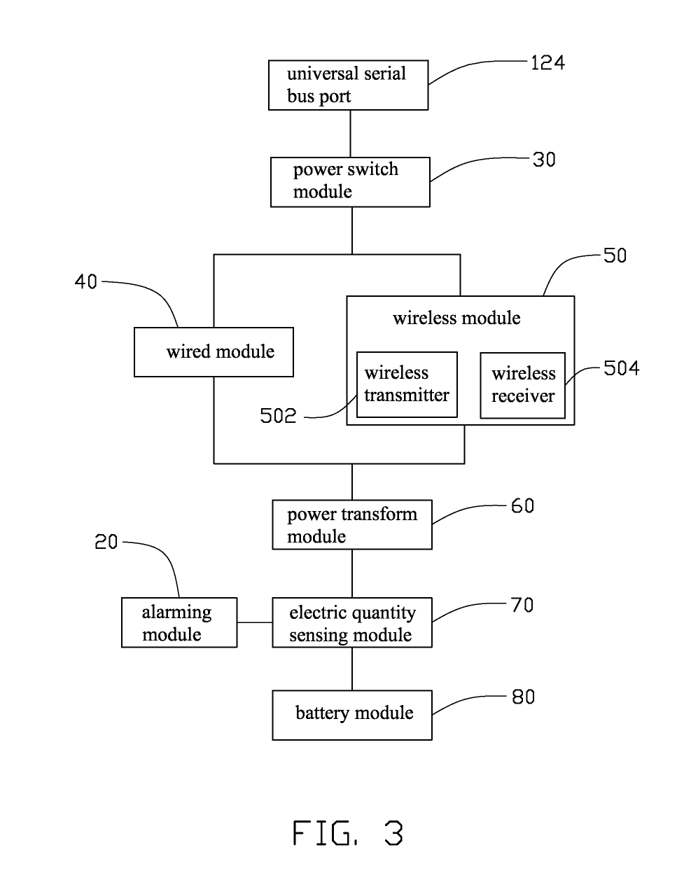

Also referring to FIG. 3, The main body 12 includes a power switch module 30, a wired module 40, a wireless module 50, a power transform module 60, an alarming module 20, an electric quantity sensing module 70, and a battery module 80 configured therein.

The port 124 is a universal serial bus (USB) port and is electronically connected to the power switch module 30. The power switch module 30 is separately connected to the wired module 40 and the wireless module 50. The wired module 40 and the wireless module 50 are respectively electronically connected to the power transform module 60. The power transform module 60 is connected to the electric quantity sensing module 70, and the electric quantity sensing module 70 is connected to the battery module 80.

The connecting line 14 has two connectors 142, 144 integrated at ends configured for being engaged with the port 902 of the computer 90 and the port 124 of the main body 12. The main body 12 can be connected to the computer 90 via the connecting line 14.

The optical mouse 10 can selectively function in a connected mode when it is connected to the computer 90 via the connecting line 14 (FIG. 2), or function in a wireless mode when the connecting line 14 is not used to connect the optical mouse 10 with the computer 90. The power switch module 30 controls the optical mouse 10 to alternatively function in the connected mode or in the wireless mode. When the optical mouse 10 is connected to the computer 90 with the connecting line 14, the power switch module 30 receives a signal from the computer 90 via the connecting line 14 and activates the wired module 40, which in turn activates the optical mouse 10 to function in the connected mode. When the connecting line 14 is detached from the computer 90 or the main body 12, the power switch module 30 activates the wireless module 50, which in turn activates the optical mouse 10 to function in the wireless mode.

The wired module 40 can transmit operation signal to the computer 90 via the connecting line 14, and also can deliver electric energy from the computer 90 to the battery module 80. The wireless module 50 includes a wireless transmitter 502 and a wireless receiver 504. The wireless transmitter 502 uses radio wave frequency to transmit the operation signal. The wireless receiver 504 is detachably received in a receiving slot (not shown) defined in the main body 12. When the optical mouse 10 functions in a wireless mode, the wireless receiver 504 is removed from the main body 12 and is attached to and electrically connected with the computer 90 so as to help the computer 90 to receive the operation signal sent from the transmitter 502. The wireless receiver 504 receives radio wave frequency from the wireless transmitter 502 and transforms it into electronic signal. The computer 90 receives the electronic signal from the wireless receiver 504, so as to control the displayed pointer.

The power transform module is selectively connected with the wired module or the wireless module. The power transform module is configured for transforming the electric energy provided by the battery module to be a first form suitable to operation of the wireless module when the power transform module is connected with the wireless module. The power transform module is also configured for transforming the electric energy provided by the computer to be a second form suitable to charge the battery module when the power transform module is connected with the wired module. When the optical mouse 10 functions in the connected mode, electric energy is transferred from the computer 90 to the power transform module 60, so as to recharge the battery module 80. When the optical mouse 10 functions in the wireless mode, the battery module 80 provides electric energy to the wireless module 50 via the power transform module 60.

The electric quantity sensing module 70 is used to monitor the level of electric quantity/electricity of the battery module 80 in real-time. The electric quantity sensing module 70 is electronically connected to the alarming module 20. The alarming module 20 is configured for alarming whether the level of electric quantity/electricity of the battery module 80 is full or low. The alarming module 20 includes a light-emitting diode or a sound alarm element for informing/alerting the user when the level of electric quantity/electricity of the battery module 80 is full or low. When the level of electric quantity/electricity of the battery module 80 achieves a low threshold, the alarming module 20 will intermit connection between the battery module 80 and the wireless module 50, so that the battery module 80 cannot continue to provide electric energy to the wireless module 50.

When the optical mouse 10 functions in the connected mode, the battery module 80 restores electric energy. When the optical mouse 10 functions in a wireless mode, the battery module 80 provides electric energy to the wireless module 50 via the power transform module 60.

In use, when the connecting line 14 is detached from the computer 90 or the main body 12, the power switch module 30 cannot receive electronic signal from the computer 90. The power switch module 30 activates the wireless module 50 and intermits its connection with the wired module 40. Thus, the optical mouse 10 functions in a wireless mode. The battery module 80 transmits electric energy to the power transform module 60. The electric energy is then provided to the wireless module 50 after being transformed by the power transform module 60. During use/operation of the optical mouse 10 in a wireless mode, the wireless transmitter 502 of the wireless module 50 transmits the operation signal to the computer 90. The wireless receiver 504 receives the operation signal sent to the computer 90. Thus, the main body 12 is able to move the display pointer on the computer 90. At the same time, the electric quantity sensing module 70 monitors the level of electric quantity/electricity of the battery module 80. When the level of electric quantity/electricity of the battery module 80 is down to a low threshold, the electric quantity sensing module 70 intermits its connection with the power transform module 60 and the wireless module 50, thus the battery module 80 cannot provide electric energy to the wireless module 50. Since the battery module 80 stops providing electric energy to the wireless module 50, the optical mouse 10 stops working.

When the battery module 80 of the optical mouse 10 needs to be recharged, the user needs to connect the main body 12 to the computer 90 by the connecting line 14. The power switch module 30 receives signals from the computer 90, and then activates the wired module 40. Thus, the optical mouse 10 functions in a connected mode. The computer 90 transmits electric energy to the wired module 40 via the connecting line 14. The electric energy is then transmitted to the power transform module 60, and then to the battery module 80. During the recharging period of the battery, the user can still use/operate the optical mouse 10. At the same time, the electric quantity sensing module 70 monitors the charge level of the battery module 80. When the level of electric quantity/electricity of the battery module 80 is full, the light-emitting diode/sound alarm element of the alarming module 20 illuminates/alarms, and the battery module 80 stops being recharged. If the connecting line 14 is not removed from the optical mouse 10 or the computer 90, the optical mouse 10 remains in a connected mode, and the electric energy is still provided from the computer 90 to the battery module 80 via the connecting line 14. If the connecting line 14 is detached from the optical mouse 10 or the computer 90, the optical mouse will function in a wireless mode.

A main advantage of the optical mouse 10 is that the optical mouse 10 can selectively function in a connected mode or a wireless mode, and the optical mouse can remain in a working state when the battery module 80 is being recharged. Thus, it is convenient for the user to operate meanwhile improving work efficiency.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optical mouse for controlling a display pointer of a computer, comprising:
a main body including a wired module, a wireless module and a battery module; and
a connecting line;
wherein, when the connecting line connects the computer and the main body, the optical mouse is defined to be functioning in a connected mode, wherein the computer transmits electric energy to the battery module via the connecting line, and the main body transmits electric signal to the computer via the connecting line; when the connecting line is detached from the computer or the optical mouse, the optical mouse is defined to be functioning in a wireless mode, wherein the battery module provides electric energy to the wireless module to work.

2. The optical mouse as claimed in claim 1, wherein the main body has a port positioned at one end thereof, and the port is electronically connected to one end of the connecting line.

3. The optical mouse as claimed in claim 2, further comprising a power switch module which is electrically connected to the port, and controls the optical mouse to alternatively function in the connected mode or the wireless mode.

4. The optical mouse as claimed in claim 2, wherein the port is a universal serial bus port.

5. The optical mouse as claimed in claim 3, wherein the wireless module comprises a wireless transmitter and a wireless receiver, and the wireless receiver is attached to the computer for receiving operation signal from the wireless transmitter.

6. The optical mouse as claimed in claim 3, further comprising a power transform module which is selectively connected with the wired module or the wireless module, and is configured for transforming the electric energy provided by the battery module to be a first form suitable to operation of the wireless module when the power transform module is connected with the wireless module, and transforming the electric energy provided by the computer to be a second form suitable to charge the battery module when the power transform module is connected with the wired module.

7. The optical mouse as claimed in claim 1, further comprising an electric quantity sensing module which is electrically connected to the battery module for monitoring the electric quantity of the battery module.

8. The optical mouse as claimed in claim 7, further comprising an alarming module which is connected to the electric quantity sensing module, and is configured for alarming when the electric quantity of the battery module is full.

9. An optical mouse for controlling a display pointer of a computer, comprising:
a main body including a wired module, a wireless module and a battery module;
a connecting line being detachably attached to the main body and the computer, the connecting line being configured for transmitting electric energy from the computer to the main body and transmitting operating signal from the main body to the computer;
wherein, the optical module is defined to be functioning in a connected mode via the wired module when the connecting line connects the main body and the computer, the optical module is defined to be functioning in a wireless mode via the wireless module when the connecting line is detached from the computer or the main body.

10. The optical mouse as claimed in claim 9, wherein the main body has a port positioned at one end thereof, and the port is electronically connected to one end of the connecting line.

11. The optical mouse as claimed in claim 10, further comprising a power switch module, which is electrically connected to the port, and controls the optical mouse to alternatively function in a connected mode or wireless mode.

12. The optical mouse as claimed in claim 11, wherein the port is a universal serial bus port.

13. The optical mouse as claimed in claim 12, wherein the wireless module comprises a wireless transmitter and a wireless receiver, and the wireless receiver is attached to the computer for receiving operation signal from the wireless transmitter.

14. The optical mouse as claimed in claim 12, further comprising a power transform module which is selectively connected with the wired module or the wireless module, and is configured for transforming the electric energy provided by the battery module to be a first form suitable to operation of the wireless module when the power transform module is connected with the wireless module, and transforming the electric energy provided by the computer to be a second form suitable to charge the battery module when the power transform module is connected with the wired module.

15. The optical mouse as claimed in claim 9, further comprising an electric quantity sensing module, which is electrically connected to the battery module for monitoring the electric quantity of the battery module.

16. The optical mouse as claimed in claim 15, further comprising an alarming module, which is connected to the electric quantity sensing module, and is configured for alarming when the electric quantity of the battery module is full.
